(19) United States
(12) Patent Application Publication
(10) Pub. No.: US 2025/0073734 A1
(43) Pub. Date: Mar. 6, 2025

(54) ARM SUPPORT STRUCTURE FOR A HANDHELD INTEGRATED SPRAY PAINTING DEVICE

(71) Applicants: Bo Chen, Taizhou (CN); Xiaorong Li, Taizhou (CN); Xiaopeng Li, Taizhou (CN); Fazheng Yang, Taizhou (CN)

(72) Inventors: Bo Chen, Taizhou (CN); Xiaorong Li, Taizhou (CN); Xiaopeng Li, Taizhou (CN); Fazheng Yang, Taizhou (CN)

(21) Appl. No.: 18/460,620

(22) Filed: Sep. 4, 2023

(51) Int. Cl. B05B 15/62

(52) U.S. Cl. CPC B05B 15/62

(57) ABSTRACT

An arm support structure for a handheld integrated spray painting device, comprising a gun body, a lithium battery, an adaptor box, and an arm support. The arm support and the adaptor box form a rotatable connection through a rotating element, and the adaptor box has internal locking and unlocking mechanisms. The locking mechanism can lock the arm support at a preset position, and the unlocking mechanism allows for the adjustment of the supporting angle of the arm support after unlocking. The adaptor box serves as an intermediate connector, enabling electrical connection between the lithium battery and the gun body, and becomes part of the spray painting device. The adaptor box is equipped with an arm support with an adjustable supporting angle, which better serves the purpose of supporting the arm, relieving the wrist strain of the holder, and facilitating improved work efficiency.

### TECHNICAL FIELD

The present invention relates to an arm support structure for a handheld integrated spray painting device.

### BACKGROUND TECHNOLOGY

Handheld integrated spray painting devices are commonly used in spray painting operations, suitable for applying various types of paint such as baking paint, oil paint, and latex paint. These devices are versatile and convenient due to their detachable lithium batteries. However, the paint container on the gun body is relatively large, causing the device to be unbalanced. Long-term use can lead to wrist fatigue for the operator, necessitating breaks and reducing operational efficiency.

Existing technology, disclosed in invention patent CN214440186U, describes a painting device for building doors and windows, where a support block balances wrist pressure to reduce fatigue. However, this design lacks adjustability and doesn't adequately conform to the operator's arm. Furthermore, the handle's design is not ergonomic, limiting its appeal to consumers.

### SUMMARY OF THE INVENTION

To address the shortcomings of the existing technology, the present invention provides an arm support structure for a handheld integrated spray painting device.

The arm support structure includes a gun body, lithium battery, an adaptor box connecting the gun body and lithium battery, and a supporting arm. The gun body has a detachable paint container. The adaptor box features locking and unlocking mechanisms that enable the angle of the arm support to be adjusted.

Further, the adaptor box has upper and lower slide grooves to facilitate quick assembly of the gun body and lithium battery. The adaptor box consists of a left and right shell connected by bolts, with a rotating shaft that synchronizes with the arm support.

Additionally, the locking mechanism includes a synchronizing gear on the rotating shaft, a spring, and a locking rod inside the adaptor box. The unlocking mechanism includes a release hole, release rod, and a release spring, all built into the adaptor box.

Moreover, a torsion spring within the adaptor box influences both the left shell and the synchronizing gear, encouraging an upward rotational movement of the arm support.

Compared to existing technologies, this invention offers several advantages. The adaptor box serves as an intermediate connector, enhancing the device's overall integrity. It also features an adjustable arm support, relieving wrist pressure and improving operational efficiency. The device is easy to lock and unlock, offering convenience and market-aligned design.

### DESCRIPTION OF THE DRAWINGS

FIG. 1 is a perspective view of the arm support structure for the handheld integrated spray painting device discussed.

FIG. 2 is a schematic diagram of the adaptor box and arm support as seen in FIG. 1;

FIG. 3 is a schematic diagram with the right shell of the adaptor box hidden, as referenced from FIG. 2;

FIG. 4 is an exploded view of FIG. 3;

FIG. 5 is a schematic diagram of the locking rod;

FIG. 6 is a schematic diagram of the unlocking rod;

### DETAILED DESCRIPTION OF THE EMBODIMENTS

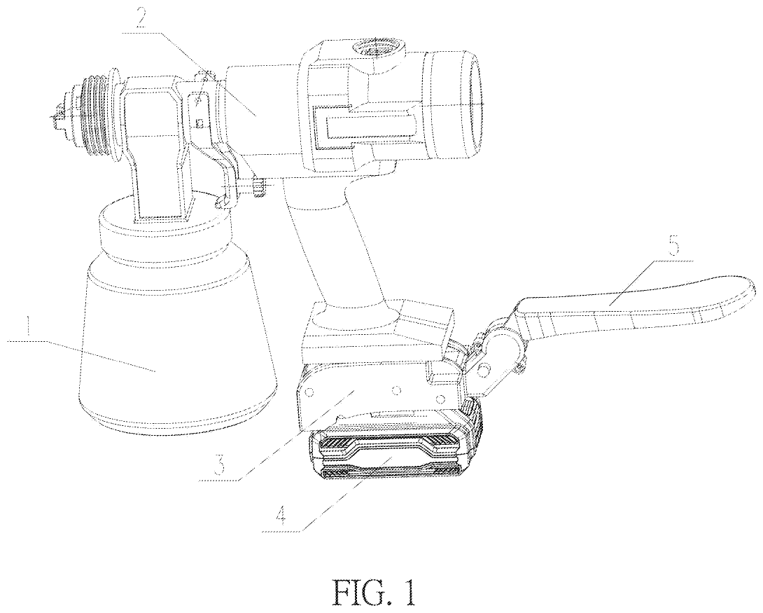

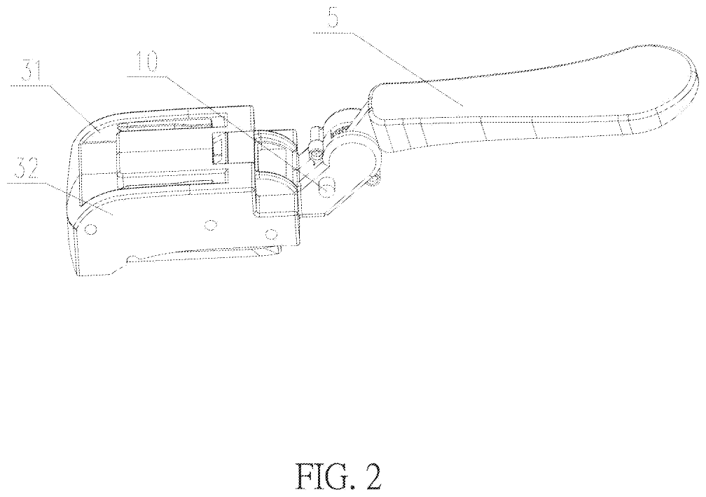

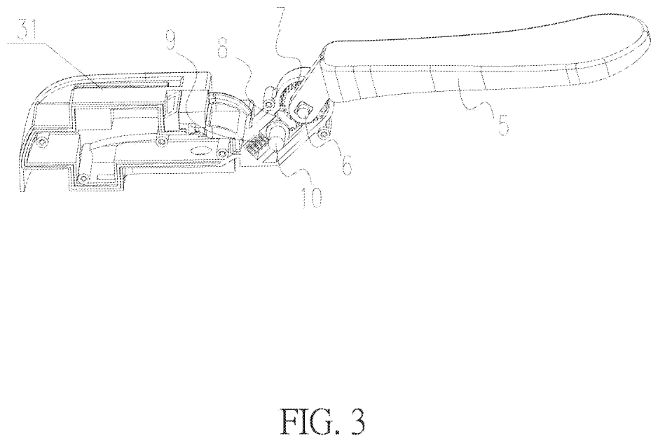

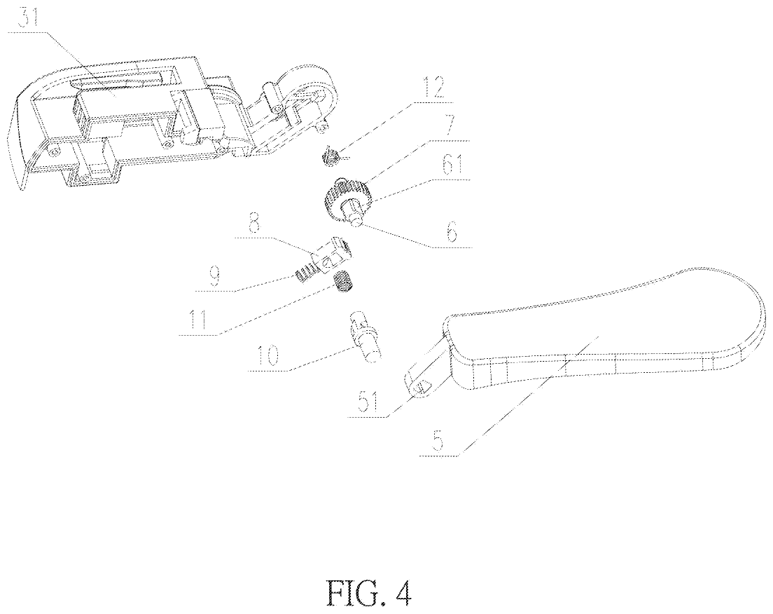

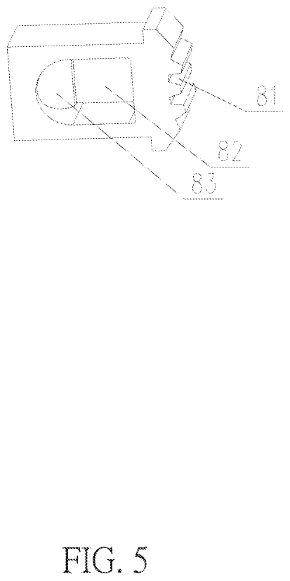

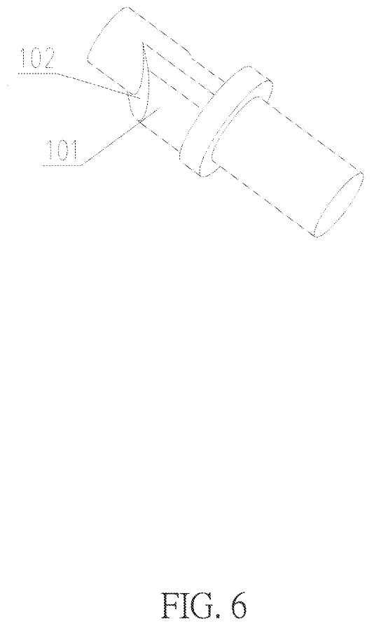

As shown in FIGS. 1-6, the present invention embodiment includes an arm support structure for a handheld integrated spray painting device, which comprises a gun body 2 (where the gun body 2 is an electric spray paint gun), a lithium battery 4, an adaptor box 3 connecting the gun body 2 and the lithium battery 4, and an arm support 5. A removable paint can 1 is mounted on the gun body 2. The arm support 5 and the adaptor box 3 form a rotatable connection through a rotating element 6. The adaptor box 3 is internally equipped with locking and unlocking mechanisms. The locking mechanism can lock the arm support 5 in a preset position, and the unlocking mechanism allows for the adjustment of the supporting angle of the arm support 5 after unlocking.

The upper part of the adaptor box 3 has an upper sliding groove, allowing for the sliding installation of the gun body 2. The lower part has a lower sliding groove, allowing for the sliding installation of the lithium battery 4, facilitating rapid assembly. The adaptor box 3 includes a left shell 31 and a right shell 32 connected by bolts. The rotating element 6 is a rotating shaft, installed between the left shell 31 and the right shell 32, synchronizing its rotation with the arm support 5.

The rotating element 6 features an integral molded driving part 61. A connecting hole 51 corresponding to the driving part 61 is provided on the arm support 5. The arm support 5 is drivingly connected to the rotating element 6 through the interaction of the square-shaped driving part 61 and the connecting hole 51.

The locking mechanism comprises a synchronizing gear 7 mounted on the rotating element 6, a spring 9 inside the adaptor box 3, and a locking rod 8. The synchronizing gear 7 always rotates synchronously with the rotating element 6. The locking rod 8 features teeth 81 matching the synchronizing gear 7 and is biased by the spring 9 to mesh with the synchronizing gear 7, thus achieving the locking function.

The unlocking mechanism includes an unlocking hole 82 in the middle of the locking rod 8, and a first inclined plane 83, an unlocking rod 10 located at the unlocking hole 82, and an unlocking spring 11 supporting the unlocking rod 10. Both the unlocking rod 10 and the unlocking spring 11 are located inside the adaptor box 3. The unlocking rod 10 features an unlocking section 101 with a second inclined plane 102 that matches the first inclined plane 83.

Inside the adaptor box 3 is a torsion spring 12. The two torsional arms of the torsion spring 12 respectively act on the left shell 31 and the synchronizing gear 7, causing the arm support 5 to always rotate upward.

In practical use, the user's hand grips the handle of the gun body 2, and the arm support 5 rests on the user's forearm, providing balance and alleviating wrist strain. To adjust the angle of the arm support 5, the user presses inward on the unlocking rod 10, overcoming the elastic force of the unlocking spring 11. At the same time, the second inclined plane 102 and the first inclined plane 83 interact, allowing the locking rod 8 to overcome the spring 9, thereby disengaging the teeth 81 from the synchronizing gear 7. The arm support 5 then rotates due to the effect of the torsion spring 12 and aligns with the user's arm. Releasing the unlocking rod 10 causes the spring 9 to bias the locking rod 8 back towards the synchronizing gear 7, re-engaging the teeth 81 and locking the arm support 5 in position.

The above description is only a preferred embodiment of the present invention and is not intended to limit the scope of the invention. Various modifications and changes can be made to the invention by those skilled in the art without departing from the spirit and scope of the invention.

I claim:

1. An arm support structure for a handheld integrated spray painting device comprising
a gun body (2), a lithium battery (4), an adaptor box (3) connecting between the gun body (2) and the lithium battery (4), and an arm support (5),
wherein the gun body (2) is equipped with a detachable paint can (1), the arm support (5) and the adaptor box (3) are rotatably connected by a rotating element (6), the adaptor box (3) has internal locking and unlocking mechanisms, the locking mechanism locks the arm support (5) at a preset position, and the unlocking mechanism allows for the adjustment of the supporting angle of the arm support (5) after unlocking

2. The arm support structure for a handheld integrated spray painting device according to claim 1, wherein an upper part of the adaptor box (3) forms an upper sliding groove and the gun body (2) is slidably installed therein; a lower part of the adaptor box (3) forms a lower sliding groove and the lithium battery (4) is slidably installed therein, facilitating rapid assembly.

3. The arm support structure for a handheld integrated spray painting device according to claim 1, wherein the adaptor box (3) includes a left shell (31) and a right shell (32) connected by bolts, and the rotating element (6) is a rotating shaft that can be rotatably mounted between the left shell (31) and the right shell (32), and the arm support (5) rotates synchronously with the rotating shaft.

4. The arm support structure for a handheld integrated spray painting device according to claim 3, wherein the rotating element (6) has an integral molded driving part (61), and a connecting hole (51) corresponding to the driving part (61) is provided on the arm support (5).

5. The arm support structure for a handheld integrated spray painting device according to claim 3, wherein the locking mechanism comprises a synchronizing gear (7) mounted on the rotating element (6), a spring (9) within the adaptor box (3), and a locking rod (8), the synchronizing gear (7) rotates synchronously with the rotating element (6), the locking rod (8) has teeth (81) matching the synchronizing gear (7) and is biased by the spring (9) to mesh with the synchronizing gear (7), thereby achieving the locking function.

6. The arm support structure for a handheld integrated spray painting device according to claim 5, wherein the unlocking mechanism comprises an unlocking hole (82) in the middle of the locking rod (8) and a first inclined plane (83), an unlocking rod (10) through the unlocking hole (82) is supported by an unlocking spring (11), both the unlocking rod (10) and the unlocking spring (11) are located inside the adaptor box (3), the unlocking rod (10) has an unlocking section (101) with a second inclined plane (102) matching the first inclined plane (83).

7. The arm support structure for a handheld integrated spray painting device according to claim 6, wherein a torsion spring (12) is located inside the adaptor box (3), the two torsional arms of the torsion spring (12) respectively act on the left shell (31) and the synchronizing gear (7), causing the arm support (5) to always exhibit an upward rotating motion.
